(19) United States
(12) Patent Application Publication
(10) Pub. No.: US 2018/0038399 A1
(43) Pub. Date: Feb. 8, 2018

(54) LIGHTWEIGHT FLOATING BLIND PANEL INSERT

(71) Applicant: SPS TECHNOLOGIES, LLC, Jenkintown, PA (US)

(72) Inventors: Mark Fischer, Mission Viejo, CA (US); Ismael Pacheco, Irvine, CA (US); Nilesh Patel, Irvine, CA (US)

(73) Assignee: SPS TECHNOLOGIES, LLC, Jenkintown, PA (US)

(21) Appl. No.: 15/670,718

(22) Filed: Aug. 7, 2017

Related U.S. Application Data
(60) Provisional application No. 62/371,380, filed on Aug. 5, 2016.

(51) Int. Cl. F16B 5/01; F16B 37/04; F16B 39/08; F16B 37/12

(52) U.S. Cl. CPC F16B 5/01; F16B 37/122; F16B 37/042; F16B 39/08; B29C 66/474

(57) ABSTRACT

An insert for use in a sandwich-type structure is provided that includes a housing defining an internal bore, a proximal flange, opposed distal flanges, and an exterior wall portion extending between the proximal flange and the opposed distal flanges. The opposed distal flanges define lateral walls arranged tangentially with a wall of the internal bore. A nut is disposed within the internal bore of the housing and configured to float therein, the nut defines a truncated flange and a hollow shaft extending from the truncated flange. The hollow shaft of the nut defines internal threads and an exterior wall, the exterior wall having a diameter at least equal to a thread lock diameter. A cap is configured for engagement with the opposed distal flanges such that the nut is floatingly captured within the internal bore of the housing.

### CROSS-REFERENCE TO RELATED APPLICATIONS

This application claims priority to and the benefit of U.S. provisional application Ser. No. 62/371,380 filed on Aug. 5, 2016. The disclosure of the above applications is incorporated herein by reference.

### FIELD

The present disclosure relates to fasteners and more specifically to blind inserts for use in sandwich-type structures such as honeycomb panels.

### BACKGROUND

The statements in this section merely provide background information related to the present disclosure and may not constitute prior art.

Sandwich-type structures, such as honeycomb panels, are used in a variety of applications that require lightweight combined with high strength. Sandwich-type structures generally include a lightweight core with face sheets or skins secured on opposite sides of the core. One such application for sandwich-type structures is in an aircraft, and more specifically interior panels of an aircraft such as flooring or doors.

These interior panels often include hardware in order to secure an object thereto or to provide other functionality. In some cases, one side of the hardware is often “blind,” where access to the side is inhibited or not possible due to the assembly of surrounding components. Such hardware may include a fastener commonly referred to as a “panel insert” or an “inset panel fastener,” which generally includes a casing having a threaded nut floating therein and enclosed by a cap. An example of such a fastener is shown in U.S. Pat. No. 7,195,436.

As shown in FIG. 1, these panel inserts may be installed in the “blind” application where the back-side of the insert is not exposed to an outside environment for installation and/or removal. As shown, the panel inserts 10 generally include a body portion 12, a cap 14, and a nut 16 disposed within the body portion 12 and enclosed therein by the cap 14. The panel insert 10 is installed within a sandwich panel 18, which generally includes face sheets 20 and a core 22. Generally, the panel inserts 10 are installed within openings formed through one face sheet 20 and the core 22, and then are secured within the opening by a potting compound.

Because weight is an important design criteria in aerospace applications, designers are constantly pursuing options to reduce weight in all components, including these panel insert fasteners, while also maintaining the required structural integrity.

### SUMMARY

In one form, an insert for use in a sandwich-type structure is provided that comprises a housing defining an internal bore, a proximal flange, opposed distal flanges, and an exterior wall portion extending between the proximal flange and the opposed distal flanges. The opposed distal flanges define lateral walls arranged tangentially with a wall of the internal bore. A nut is disposed within the internal bore of the housing and is configured to float therein, the nut defining a truncated flange and a hollow shaft extending from the truncated flange. The hollow shaft defines internal threads and an exterior wall, the exterior wall having a diameter equal to a thread lock diameter. In one variation, the exterior wall extends along the entire length of the hollow shaft. A cap is configured for engagement with the opposed distal flanges such that the nut is floatingly captured within the internal bore of the housing.

In alternate forms, the truncated flange of the nut defines opposed cutouts, which may define an arcuate geometry. In another form, the exterior wall portion of the housing defines a textured surface. In still another form, the proximal flange of the housing defines at least one radial recess to accommodate a potting compound upon final assembly of the insert and the sandwich structure. Further still, the proximal flange of the housing defines a textured sidewall in another form of the present disclosure.

The components of the insert may be any of a variety of materials. In one form, the housing and cap is an aluminum alloy material and the nut is stainless steel material. In another form, the components may be selected from the group consisting of a plastic material, composite material, a titanium alloy, and carbon steel.

In another form, the opposed distal flanges of the housing define a slotted region such that the nut is disposed within the slotted region of the housing. In other form, the outer diameter of the hollow shaft of the nut is smaller than an inner diameter of the bore of the housing.

In another form, a sandwich panel is provided that comprises an insert as described herein. Also, an aircraft having a sandwich panel with an insert is also provided by the teachings of the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a side cross-sectional view of a prior art blind panel insert according to the prior art;

FIG. 2A is a perspective view of an insert constructed in accordance with the principles of the present disclosure;

FIG. 2B is a top exploded perspective view of the insert of FIG. 2A;

FIG. 2C is a bottom exploded perspective view of the insert of FIG. 2A;

FIG. 3 is a side cross-sectional view of the insert installed within a sandwich-type structure in accordance with the teachings of the present disclosure;

FIG. 4 is a perspective view of a housing of the insert constructed in accordance with one form of the present disclosure;

FIG. 5A is a perspective view of a nut of the insert constructed in accordance with one form of the present disclosure;

FIG. 5B is a perspective view of another form of a nut of the insert constructed in accordance with one form of the present disclosure; and

FIG. 6 is a perspective view of the housing of FIG. 4 and the nut of FIG. 5 in accordance with the teachings of the present disclosure.

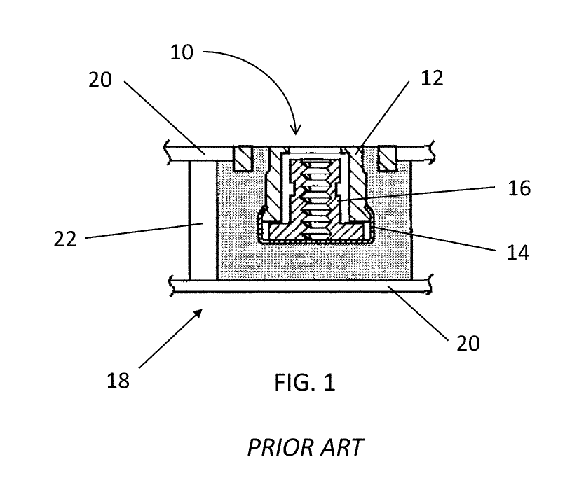

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

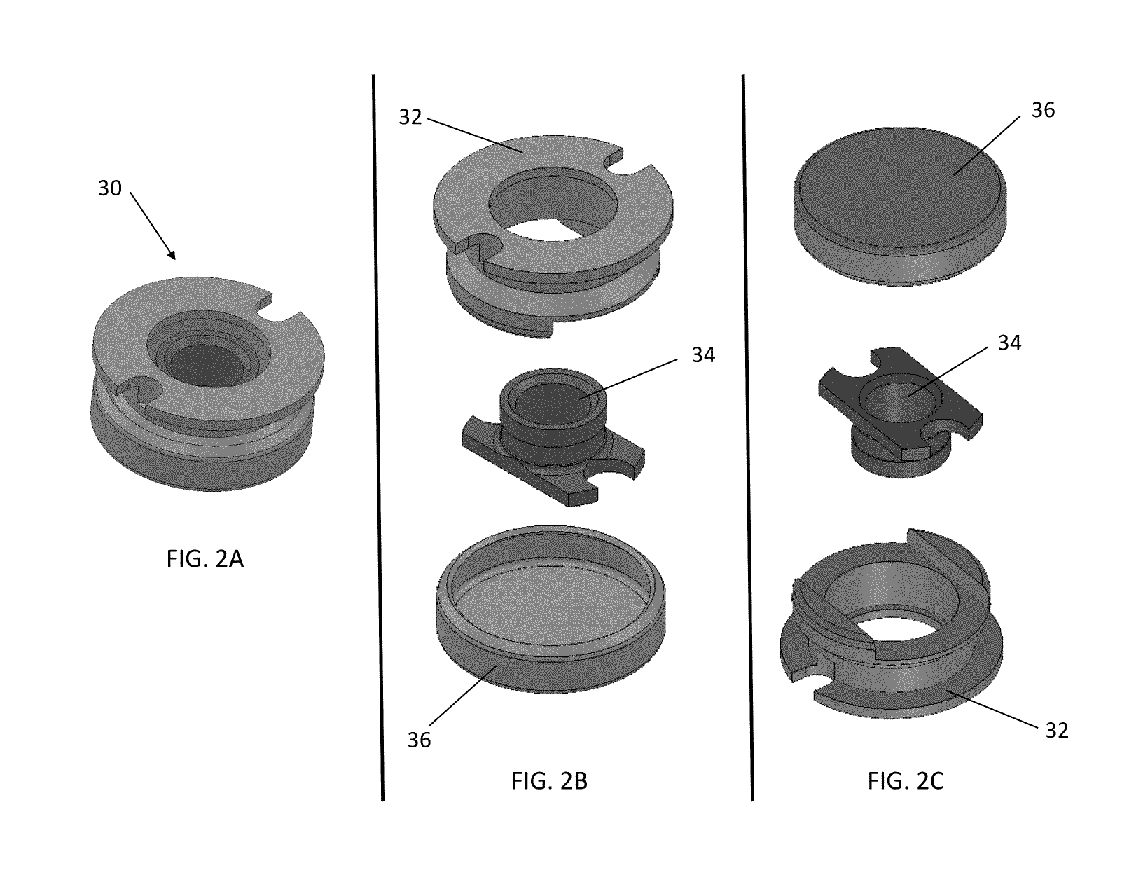

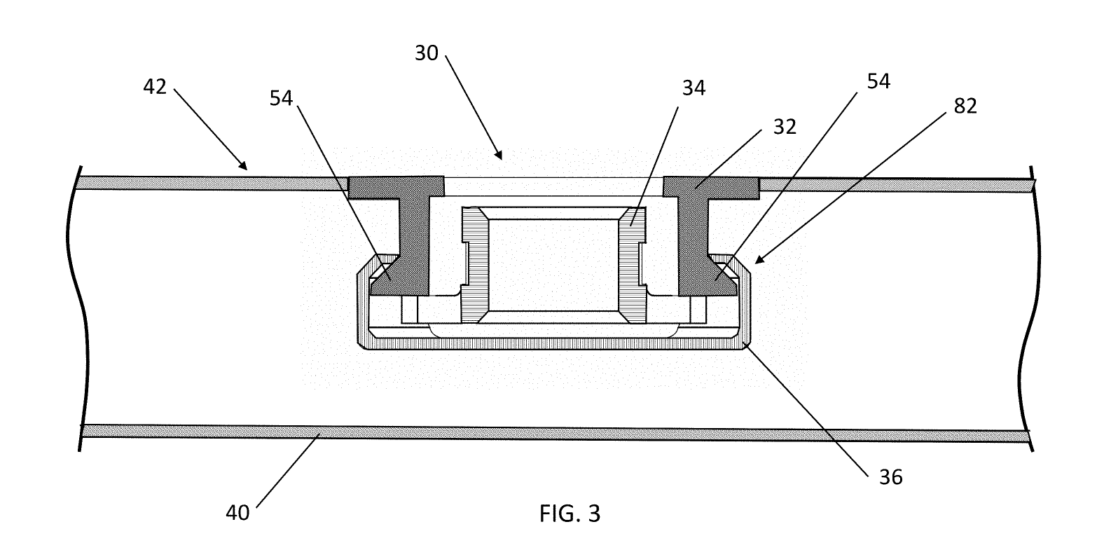

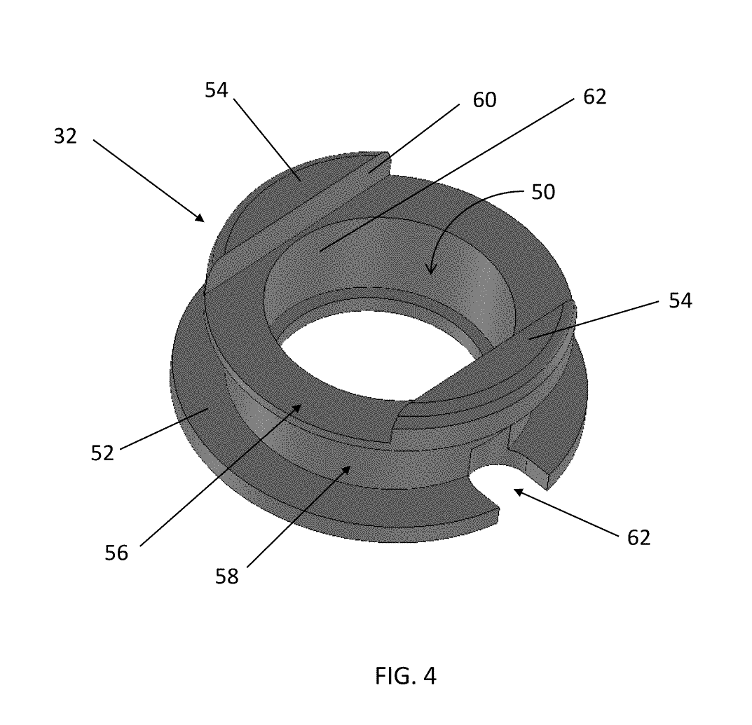

Referring to FIGS. 2A-2C and 3 a lightweight blind insert for use in a sandwich-type structure is illustrated and generally indicated by reference numeral 30. The insert 30 in one form of the present disclosure is provided in three (3) pieces, namely, a housing 32, a floating internal nut 34, and a cap 36. As shown in FIG. 3, the insert 30 is blind such that the cap 36 is not accessible from the side of the face sheet 40 of the sandwich-type structure 42.

As best shown in FIG. 4, the housing 32 defines an internal bore 50, a proximal flange 52, opposed distal flanges 54 defining a slotted region 56, and an exterior wall portion 58 extending between the proximal flange 52 and the opposed distal flanges 54. The opposed distal flanges 54 define lateral walls 60 (only one lateral wall 60 shown in FIG. 4) arranged tangentially with a wall 62 of the internal bore 50 in one form of the present disclosure. The proximal flange 52 of the housing 32 also defines at least one radial recess 62 to accommodate a potting compound upon final assembly of the insert within the sandwich structure 42.

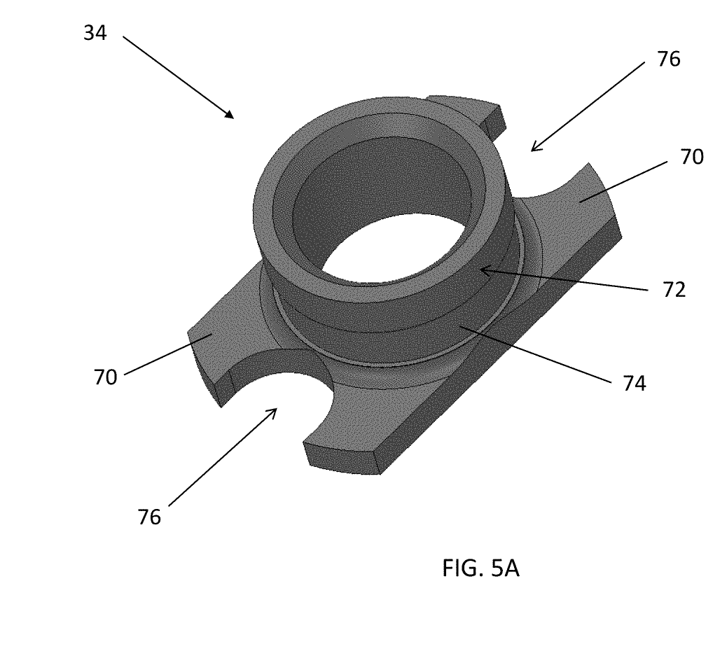

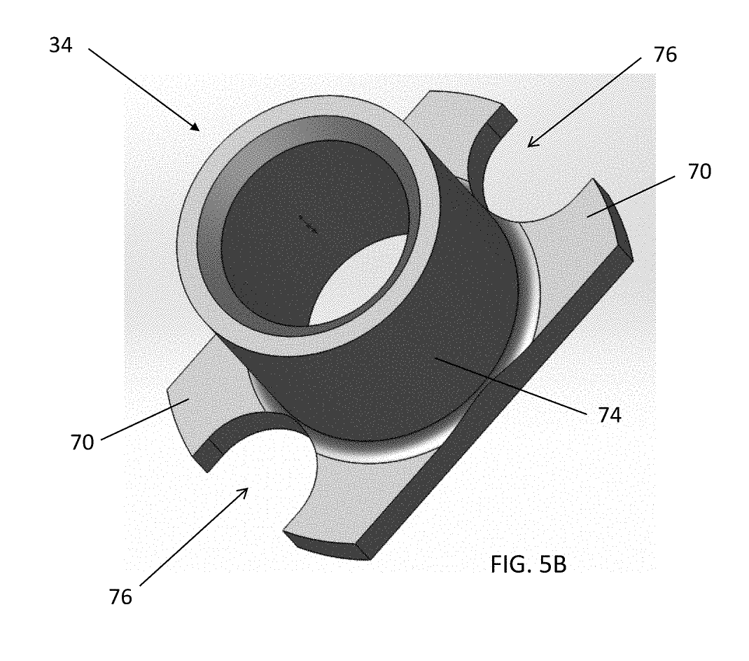

Referring now to FIG. 5A, the nut 34 defines a truncated flange 70 and a hollow shaft 72 extending from the truncated flange 70. The hollow shaft 72 defines internal threads (not shown) to receive a threaded component (also not shown) and an exterior wall 74. Advantageously, the exterior wall 74 has a diameter approximately equal to, or slightly greater than, a thread lock diameter, which is generally the minimum diameter at which the threads of a mating fastener will plastically deform the exterior wall 74. This smaller diameter of the exterior wall 74 thus results in a more lightweight insert 30. Additionally, the truncated flange 70 provides weight savings through the opposed cutouts 76, which in one form define an arcuate configuration as shown. Such a truncated flange 70 has not heretofore been contemplated due to a decrease in strength, less efficient load path, and possible stress concentrations created by the discontinuities of the truncations. It should be understood that other shapes may be provided as truncations in order to save weight, and the arcuate configurations should not be construed as limiting the scope of the present disclosure.

In another form as shown in FIG. 5B, the hollow shaft 72 may have the exterior wall 74 with a thread lock diameter extending along its entire length, rather than just a portion thereof shown in FIG. 5A.

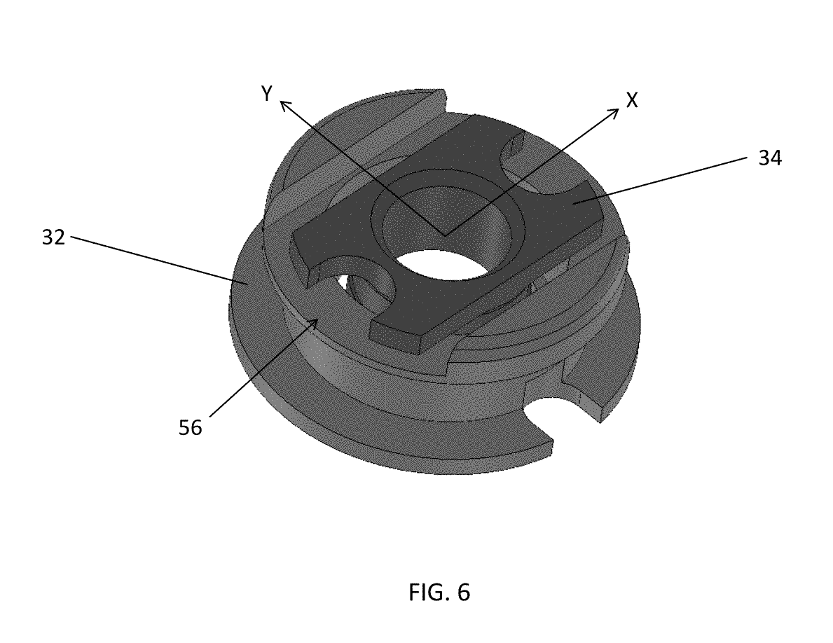

As further shown in FIG. 6, the nut 34 is configured to be disposed within the internal bore 50 of the housing 32 and to float therein, and more specifically, within the slotted region 56 along the axes X and Y as shown because the outer diameter of the hollow shaft 72 of the nut 34 is smaller than the inner diameter of the bore 50 of the housing 32. This “floating” capability compensates for assembly tolerances and allows for a more efficient assembly operation when adjacent components such as a threaded component (not shown) are secured to the nut 34.

Referring back to FIGS. 2B, 2C, and 3, a cap 36 is configured for engagement with the opposed distal flanges 54 of the housing 32 such that the nut 34 is floatingly captured within the internal bore 50 of the housing 32. In one form, a distal edge 82 of the cap 36 is plastically deformed to capture the distal flanges 54 of the housing, which is best shown in FIG. 3. It should be understood that this plastic deformation is merely one form of capturing the nut 34 within the housing 32 and should not be construed as limiting the scope of the present disclosure.

Each of the housing 32, nut 34, and cap 36 may be any material depending on specific application requirements. In one form, the housing 32 and cap 36 are an aluminum alloy material, and the nut 34 is a stainless steel material. In another form, one or more of these components may be a plastic or composite material. In still another form, the cap 36 may be a titanium alloy. The nut 34 may also be a titanium alloy or a carbon steel.

In another form, the exterior wall portion 58 may define a textured surface (not shown) in order to provide a more secure installation of the insert 30 within the sandwich-type structure 42. Similarly, the proximal flange 52 of the housing 32 may define a textured sidewall (not shown) for a more secure installation.

The lightweight insert 30 according to the present disclosure is generally used in a sandwich-type structure as illustrated herein but may also be used in other applications. Further the lightweight insert 30 is contemplated for use in an aircraft in order to provide weight savings.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An insert for use in a sandwich-type structure, the insert comprising:
a housing defining an internal bore, a proximal flange, opposed distal flanges, and an exterior wall portion extending between the proximal flange and the opposed distal flanges, the opposed distal flanges defining lateral walls arranged tangentially with a wall of the internal bore;
a nut disposed within the internal bore of the housing and configured to float therein, the nut defining a truncated flange and a hollow shaft extending from the truncated flange, the hollow shaft defining internal threads and an exterior wall, the exterior wall having a diameter at least equal to a thread lock diameter; and
a cap configured for engagement with the opposed distal flanges such that the nut is floatingly captured within the internal bore of the housing.

2. The insert according to claim 1, wherein the diameter of the exterior wall of the hollow shaft of the nut extends along an entire length of the hollow shaft.

3. The insert according to claim 1, wherein the truncated flange defines opposed cutouts.

4. The insert according to claim 3, wherein the opposed cutouts define an arcuate configuration.

5. The insert according to claim 1, wherein the exterior wall portion of the housing defines a textured surface.

6. The insert according to claim 1, wherein the proximal flange of the housing defines at least one radial recess.

7. The insert according to claim 1, wherein the proximal flange of the housing defines a textured sidewall.

8. A sandwich panel comprising at least one insert according to claim 1.

9. An aircraft having a sandwich panel according to claim 8.

10. The insert according to claim 1, wherein the housing and the cap are an aluminum alloy material and the nut is a stainless steel material.

11. The insert according to claim 1, wherein at least one of the housing, the nut, and the cap is a material selected from the group consisting of a plastic material and a composite material.

12. The insert according to claim 1, wherein the cap is a titanium alloy material.

13. The insert according to claim 1, wherein the nut is a material selected from the group consisting of a titanium alloy and a carbon steel material.

14. The insert according to claim 1, wherein the opposed distal flanges of the housing define a slotted region such that the nut is disposed within the slotted region of the housing.

15. The insert according to claim 1, wherein an outer diameter of the hollow shaft of the nut is smaller than an inner diameter of the bore of the housing.

16. The insert according to claim 1, wherein a distal edge of the cap is plastically deformed to capture the distal flanges of the housing.

17. An insert for use in a sandwich-type structure, the insert comprising:
a housing defining an internal bore, a proximal flange, opposed distal flanges, and an exterior wall portion extending between the proximal flange and the opposed distal flanges, the opposed distal flanges defining lateral walls arranged tangentially with a wall of the internal bore and defining a slotted region;
a nut disposed within the internal bore of the housing and disposed within the slotted region and configured to float therein, the nut defining a truncated flange and a hollow shaft extending from the truncated flange, the hollow shaft defining internal threads and an exterior wall, the exterior wall having a diameter at least equal to a thread lock diameter; and
a cap configured for engagement with the opposed distal flanges such that the nut is floatingly captured within the internal bore of the housing.

18. The insert according to claim 17, wherein the truncated flange defines opposed cutouts.

19. The insert according to claim 17, wherein the proximal flange of the housing defines at least one radial recess.

20. The insert according to claim 17, wherein the diameter of the exterior wall of the hollow shaft of the nut extends along a portion of a length of the hollow shaft.
